(19) United States
(12) Patent Application Publication
(10) Pub. No.: US 2008/0029549 A1
(43) Pub. Date: Feb. 7, 2008

(54) Grease gun

(76) Inventor: Richard M. Hulden, Taylors, SC (US)

Correspondence Address: J. BENNETT MULLINAX, LLC, P. O. BOX 26029, GREENVILLE, SC, 29616-1029, US

(21) Appl. No.: 11/498,475

(22) Filed: Aug. 3, 2006

(51) Int. Cl. G01F 11/00

(52) U.S. Cl. 222/256

(57) ABSTRACT

A grease gun is provided. The grease gun has a cylindrical wall that is made of aluminum. The cylindrical wall defines an interior and has both an inner surface and an outer surface. In some aspects, the cylindrical wall is seamless and the outer surface defines a gripping element thereon.

### FIELD OF THE INVENTION

The present invention relates generally to a grease gun for delivering grease to an object. More particularly, the present application involves a grease gun that has a cylindrical wall made of aluminum.

### BACKGROUND

Grease guns are used to dispense grease for servicing an object such as a piece of machinery. A typical grease gun includes a grease container that stores grease for dispensing. A low pressure piston is provided that forces a quantity of grease into a chamber. Conventional grease guns also have a high pressure piston that forces the quantity of grease from the chamber out of a nozzle or other fitting to the object being serviced. The high pressure piston can be hydraulically or pneumatically actuated. Alternatively, a hand lever can be operably linked to the high pressure piston so that when a user actuates the hand lever the high pressure piston forces grease from the grease gun.

Grease containers in present grease guns are steel cylinders that have one end in communication with the chamber and the other end fitted with an end cap. The low pressure piston is located inside of the grease container and generally has a rubber resilient member. The rubber resilient member contacts the inner wall of the grease container and acts as a plunger to force grease in the grease container towards the end in communication with the chamber. The low pressure piston can be urged towards the chamber by use of a spring, threaded rod or other mechanism.

A square piece of steel is normally provided in order to make a grease container. The steel piece is rolled and formed by a die into a cylindrical shape. Formation in this manner results in the presence of a seam on the inner surface that is subsequently machined so that the resulting inner surface is smooth. The grease container is normally elongated and is often grasped by a user when operating or transporting the grease gun. Grasping of the grease container may be difficult as grease inevitably finds its way onto its outer surface. As such, the outer surface is sometimes provided with one or more gripping elements. The circumference of the outer surface can be stamped at one or more locations to depress the outer surface so that a pattern is formed thereon. For example, the outer surface can be stamped so that a pattern of pyramids are made that better allow the user to grip the grease container.

Stamping of the outer surface of the grease container is problematic in that the stamping force distorts the inner surface of the container. Instead of being smooth, the inner surface of the grease container is wavy. One such example of a cylindrical wall 14 of a grease container is shown in FIG. 2. Here, gripping elements 22, 74 and 76 are stamped on the outer surface 20 of the cylindrical wall 14. Corresponding bumps 80, 82 and 84 are made on the inner surface 18 through formation of the gripping elements 22, 74 and 76. Also, machining of the seam 78 or failing to remove the entire seam 78 may further distort the inner surface 18. Distortion of the inner surface 18 interferes with operation of the low pressure piston as the rubber resilient member is not uniformly urged forward. Distortions may cause varying amounts of grease to be forced into the chamber, premature wear on the rubber resilient member, and the introduction of air pockets into the grease.

Current attempts to prevent distortion of the inner surface of the grease container involve increasing the thickness of the cylinder wall and increasing the strength of the steel used. The inner surface of the resulting container is generally smooth after stamping as the strength of the cylinder wall is sufficient to prevent distortion of the inner surface. This approach is problematic as it increases the overall cost of the grease gun and results in a much larger and heavier grease container. As such, there remains room for variation and improvement within the art.

### SUMMARY

Various features and advantages of the invention will be set forth in part in the following description, or may be obvious from the description, or may be learned from practice of the invention.

The present invention provides for in one aspect a grease gun that has a grease container with a cylindrical wall that is made of aluminum. The cylindrical wall has both an inner surface and an outer surface and defines an interior for holding grease. A first piston is disposed at least partially in the interior of the cylindrical wall. The first piston has a resilient member that engages the inner surface about the circumference of the inner surface. The first piston also has a spring that biases the resilient member towards an end of the cylindrical wall. The first piston also includes a rod that is disposed through the spring. The first piston is configured for urging grease in the interior of the cylindrical wall into a chamber. A second piston is present and is configured for urging grease that is in the chamber out of the chamber. The second piston is configured for urging grease at a higher pressure than the first piston.

Also provided for in accordance with another aspect of the invention is a grease gun as immediately discussed in which the cylindrical wall is seamless.

The present invention includes an exemplary embodiment of the grease gun as described above in which the outer surface of the cylindrical wall defines a gripping element thereon.

Also provided in another aspect is a grease gun as immediately discussed in which a single gripping element is present on the outer surface. The gripping element is formed by a plurality of pyramid shaped members arranged next to one another. The plurality of pyramid shaped members are formed by stamping the outer surface.

The present invention also provides for, in another aspect, a grease gun with a grease container that has a cylindrical wall that is made of aluminum. The cylindrical wall defines an interior. The cylindrical wall is also seamless and has both an inner surface and an outer surface. The outer surface of the cylindrical wall defines a gripping element thereon.

Also provided for in accordance with one aspect of the present invention is a grease gun as immediately discussed in which a single gripping element is present on the outer surface. The gripping element is formed by a plurality of pyramid shaped members arranged next to one another. The plurality of pyramid shaped members are made by through a molding process.

Another aspect of the present invention involves a grease gun as described above in which the cylindrical wall has a length. The inner diameter of the cylindrical wall is consistent throughout the length so that the inner surface is smooth along the length of the cylindrical wall.

Yet another aspect of the present invention resides in a grease gun as described above in which the cylindrical wall is formed by extrusion. The cylindrical wall has threading on opposite ends thereof.

An additional aspect of the present invention is provided in a grease gun that has a grease container with a cylindrical wall made of aluminum. The cylindrical wall defines an interior. The cylindrical wall is also seamless and has both an inner surface and an outer surface. The outer surface defines a gripping element. The cylindrical wall weighs at most 22 ounces and has a thickness from 0.0625 inches to 0.25 inches. The cylindrical wall also has a length. The inner diameter of the cylindrical wall is the same throughout the length so that the inner surface is smooth along the length. A first piston is disposed at least partially in the interior of the cylindrical wall. The first piston has a resilient member that engages the inner surface about the circumference of the inner surface. The first piston has a spring that biases the resilient member towards an end of the cylindrical wall. The first piston has a rod that is disposed through the spring. The first piston is configured for urging grease in the interior of the cylindrical wall into a chamber. A second piston is present and is configured for urging grease in the chamber out of the chamber. The second piston is configured to urge grease at a higher pressure than the first piston.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a cross-sectional view of a cylindrical wall of a prior grease container of a grease gun.

FIG. 2 is a cross-sectional view of a grease gun in accordance with one exemplary embodiment of the present invention.

FIG. 3 is a front view of a cylindrical wall of a grease container of a grease gun in accordance with one exemplary embodiment of the present invention.

FIG. 4 is a cross-sectional view taken along line 4-4 of FIG. 3.

FIG. 5 is a cross-sectional view taken along line 5-5 of FIG. 3.

FIG. 6 is a close-up front view of a portion of a cylindrical wall of a grease container in accordance with one exemplary embodiment of the present invention that shows a pattern of the gripping element.

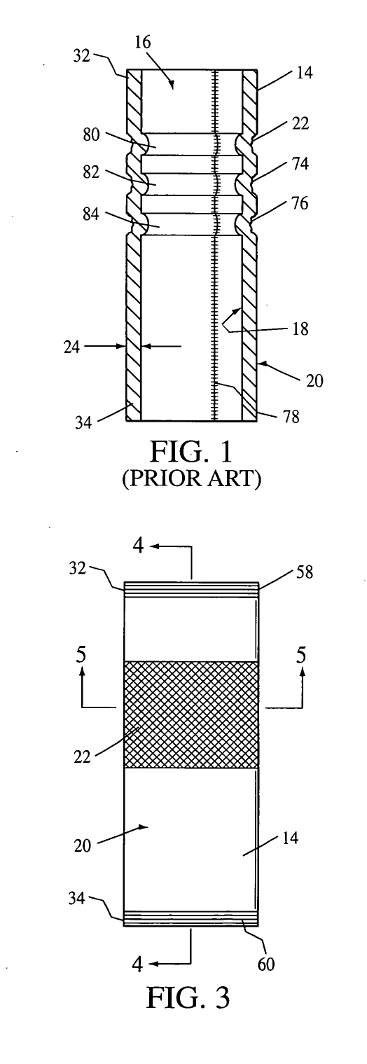

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a grease gun 10 that dispenses grease 52 to an object for servicing. The grease gun 10 includes a grease container 12 that has a cylindrical wall 14 made of aluminum. The outer surface 20 of the cylindrical wall 14 can be stamped in order to form one or more gripping elements 22 thereon that assist the user in grasping and transporting the grease gun 10. In such instances, the inner surface 18 of the cylindrical wall 14 opposite the gripping elements 22 is smooth and does not have bumps brought about by formation of the gripping elements 22. A first piston 36 that forces grease 52 from the grease container 12 will more easily slide along the smooth inner surface 18. Wear on the first piston 36 and leakage from the grease container 12 may also be reduced upon the elimination of bumps from the inner surface 18.

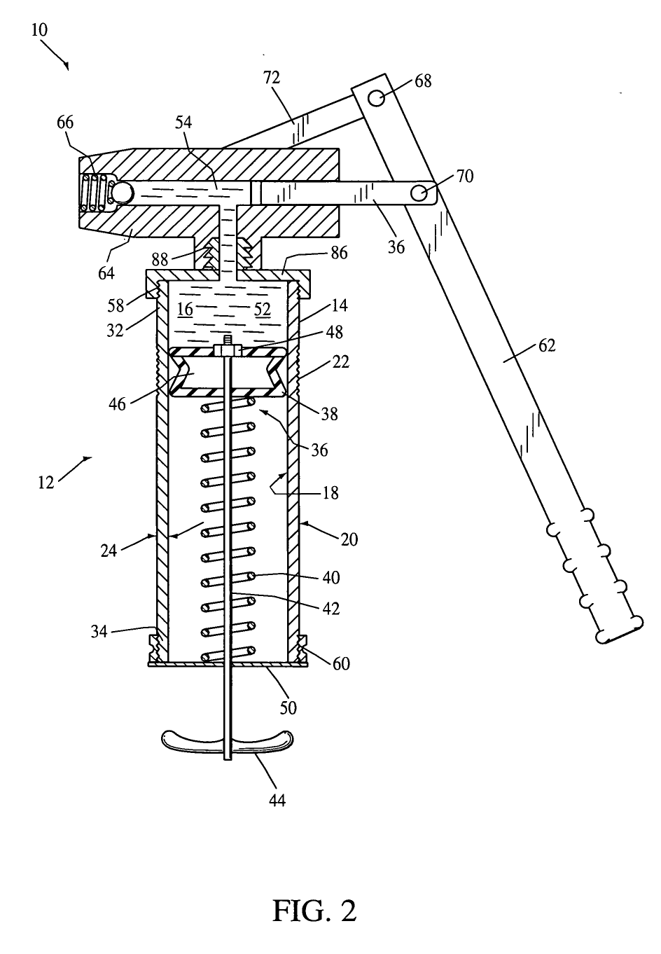

FIG. 2 shows a grease gun 10 in accordance with one exemplary embodiment of the present invention. A grease container 12 is present that holds grease 52 for dispensing. A first piston 36 forces grease 52 from grease container 12 into a chamber 54. The user can move hand lever 62 in order to actuate a second piston 56 that forces grease 52 in the chamber 54 out of an outlet nozzle 66 to the object being serviced.

The grease container 12 has a cylindrical wall 14 that defines an interior 16 into which the first piston 36 is at least partially disposed. The first piston 36 includes a mounting member 46 onto which a resilient member 38 is mounted. The resilient member 38 contacts the inner surface 18 of cylindrical wall 14. The resilient member 38 can be made of a variety of materials, for instance the resilient member 38 may be made of rubber or a thermoplastic material. The resilient member 38 may make a single seal with the inner surface 18 or may make a double seal as shown in FIG. 2.

A rod 42 is also included in the first piston 36 and is attached to the mounting member 46 by a nut 48. In this manner, the position of rod 42 is fixed with respect to mounting member 46. Threading 60 on end 34 of the cylindrical wall 14 is used in order to releasably attach an end cap 50 onto end 34. Although shown as using external threading 60 to attach end 34 to end cap 50, other forms of attachment are possible. For example, end cap 50 can be friction fit, welded or mechanically fastened to end 34. Rod 42 is disposed through a hole in end cap 50 and has a handle 44 attached to one end. Spring 40 is located between and engages both mounting member 46 and end cap 50. As such, spring 40 acts to urge the mounting member 46, and attached components, upwards in FIG. 2 to force grease 52 in the interior 16 out of an upper end 32 of the cylindrical wall 14.

In the embodiment shown in FIG. 2, the chamber 54 is defined in a dispensing portion 64 of the grease gun 10. The grease container 12 is releasably attached to the dispensing portion 64 by way of a connector 88 located on cap 86 that is in turn releasably attached to threading 58 on end 32. It is to be understood that the connection between grease container 12 and dispensing portion 64 shown in FIG. 2 is but one example and that various ways of releasably attaching these two components are possible. In a similar manner cap 86 can be friction fit, welded or mechanically fastened to end 32. Alternatively, cap 86 need not be present in other embodiments. Here, end 32 can be directly engaged to dispensing portion 64.

A user may grasp and push hand lever 62 towards the grease container 12. Hand lever 62 is connected to link 72 by pin 68. Link 72 is likewise attached to dispensing portion 64 through a pivot connection. Additionally, hand lever 62 is connected to second piston 56 by pin 70. Movement of hand lever 62 causes the second piston 56 to slide horizontally within the dispensing portion 64. Movement of the second piston 56 to the left in FIG. 2 causes grease 52 in the chamber 54 to be forced out of the outlet nozzle 66 and dispensed from the grease gun 10. A hose, fitting or other component can be connected to outlet nozzle 66 to receive the dispensed grease 52. The force of the first piston 36 exerted by spring 40 is selected to be low enough to keep the grease 52 from overcoming the force needed to open outlet nozzle 66. The force exerted by the second piston 56 is high enough to open the outlet nozzle 66 and force grease 52 from the grease gun 10. As such, the second piston 56 normally operates at a higher pressure than the first piston 36.

The grease container 12 can be filled with grease 52 by drawing from a bulk supply or by pumping the grease 52 into the grease container 12. Alternatively, prefilled cartridges can be used in order to introduce grease 52 into the grease container 12. The grease container 12 can be detached from the dispensing portion 64 In order to refill the grease container 12. The mounting member 46 and the resilient member 38 will generally be located at the end 32 once the grease container 12 runs out of grease 52. The handle 44 may be pulled by the user in order to move the mounting member 46 from end 32 to compress the spring 40 and provide space in interior 16 for adding grease 52.

The exterior of the cylindrical wall 14 is shown in FIG. 3. A variety of manufacturing processes may be used in order to make the cylindrical wall 14. For example, the cylindrical wall 14 can be extruded. The process used to make the cylindrical wall 14 can be selected in order to result in a cylindrical wall 14 that is seamless. As more clearly shown in FIG. 5, the inner surface 18 does not have a seam and therefore does not have to be machined in order to remove a seam. A gripping element 22 is present on the outer surface 20 of the cylindrical wall 14 in order to assist the user in grasping the cylindrical wall 14. In this manner, the user may more easily hold the grease container 12 and grease gun 10 during operation, transport and servicing. The gripping element 22 is generally formed by stamping the cylindrical wall 14 so that a plurality of members and indentations are formed in a repeating pattern. However, it is to be understood that the gripping element 22 can be formed in various ways in accordance with other exemplary embodiments. For example, the gripping element 22 is formed by a molding process in accordance with one exemplary embodiment.

FIG. 6 is a close-up view of a portion of the outer surface 20 that shows the gripping element 22 in greater detail. Here, a plurality of pyramid shaped members 30 are formed on the outer surface 20 and are arranged next to one another into a pattern that makes up the gripping element 22. Although shown as being pyramid shaped, it is to be understood that this is just one example of how the members 30 can be shaped and that other shapes are possible in accordance with other exemplary embodiments. Also, it is to be understood that FIG. 6 shows only a portion of the gripping element 22 and that the pattern of pyramid shaped members 30 extend around the circumference of the outer surface 20 and in the axial direction of the cylindrical wall 14 as shown in FIG. 3. The gripping element 22 can have the same pattern of members and indentations throughout, or may have varying patterns of members and indentations. Further, the members and indentations of the gripping element 22 may be of any size or shape in accordance with various exemplary embodiments.

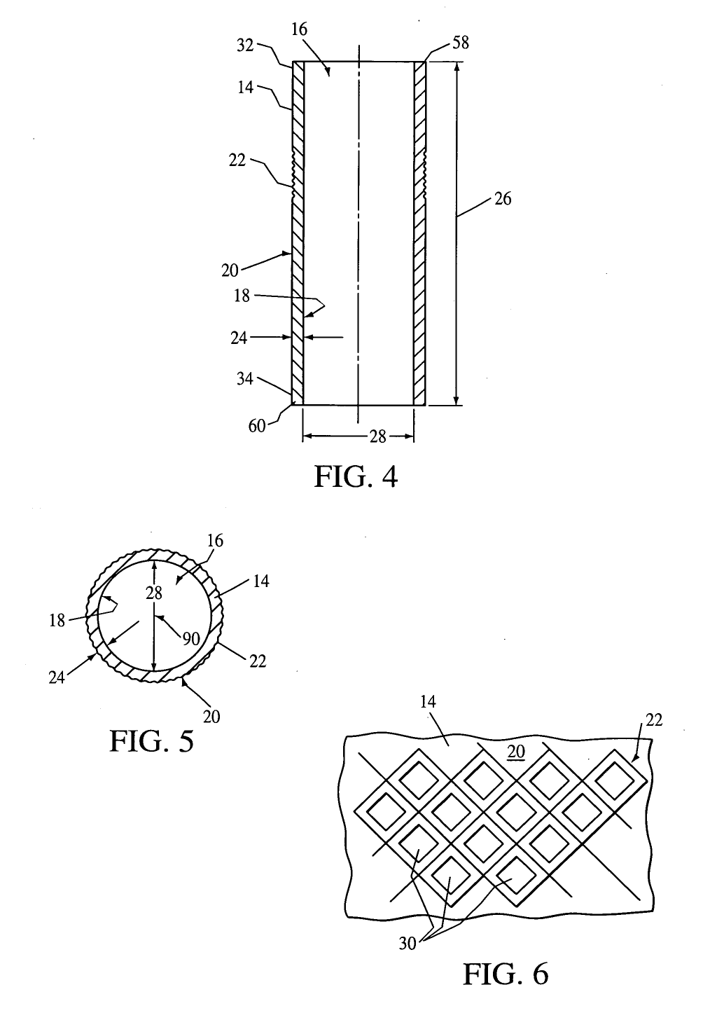

Formation of the gripping element 22 causes indentations on the outer surface 20 so that the thickness 24 of the cylindrical wall 12 is reduced in the area of the gripping element 22 as can be more clearly seen in the cross-sectional views of FIGS. 4 and 5. The thickness 24 of cylindrical wall 14 is 0.125 (one eighth) inches thick in accordance with one embodiment. Other embodiments exist in which the thickness 24 is from 0.0625 (one sixteenth) to 0.75 (three fourths) of an inch. It is to be understood that the thickness 24 can be selected to be of any size to allow for the gripping element 22 to be formed without forming bumps on the inner surface 18 that decrease the inner diameter 28 opposite the gripping element 22.

The cylindrical wall 14 is thus made so that the inner surface 18 opposite the gripping element 22 is not deformed and remains smooth. As shown in FIGS. 4 and 5, the inner surface 18 of the cylindrical wall 14 is smooth along its length 26. As bumps or other distortions are not present on the inner surface 18, the resilient member 38 will more evenly contact the inner surface 18 and move against the inner surface 18 during movement of the first piston 36. The resilient member 38 will experience reduced wear as the inner surface 18 is smooth opposite the resilient member 38. As such, the resilient member 38 will last longer and will allow less leakage of grease 52. Additionally or alternatively, as the resilient member 38 will be subjected to less wear, a less robust resilient member 38 can be incorporated into the first piston 36.

Although described as being smooth along the length 26 of the cylindrical wall 14, the inner surface 18 need not be smooth along its entire length 26 in other embodiments. For example, the inner surface 18 may only be smooth along the portion of the length 26 that is traveled by the resilient member 38. Alternatively, the inner surface 18 may have bumps or other distortions at locations that are not opposite the gripping element 22. Further, smaller grooves or cuts may be present on the inner surface 18 that may be made through normal use of the cylindrical wall 14. For example, small grooves may be formed in the direction of axis 90 on the inner surface 18 by movement of the resilient member 38. In these instances, the inner surface 18 is still considered smooth as smaller cuts and grooves do not cause the inner surface 18 to be wavy and tend not to interfere with movement of the resilient member 38. As such, the inner diameter 28 of the cylindrical wall 14 is constant in the direction of axis 90 in the area opposite gripping element 22. Again, the inner diameter 28 may be constant throughout the entire length 26 or through only a portion of the length 26. A constant inner diameter 28 is to be understood as being present even though indentations or minor bumps such as grooves, cuts or ridges may be present on the inner surface 18. The inner surface 18 is smooth in that bumps formed by formation of the gripping element 22 are not present even though smaller grooves, for example formed by extrusion of the cylindrical wall 14, are present.

The cylindrical wall 14 is made of aluminum. The use of aluminum allows for the thickness 24 of the cylindrical wall 14 to be sized so that formation of the gripping element 22 does not cause a distortion or bump to be made on the inner surface 18. The use of aluminum is also advantageous in that the cylindrical wall 14 will be lighter than cylindrical walls 14 made of other materials thus helping to reduce the overall weight of the grease gun 10. Additionally, the use of aluminum results in a stronger cylindrical wall 14 that is more resistant to denting in instances where the grease gun 10 is dropped or otherwise inadvertently impacted. As the cylindrical wall 14 is less resistant to denting, the first piston 36 is more likely to function normally thus resulting in a longer life of the grease gun 10. Although the length 26 of the cylindrical wall 14 can be any distance, length 26 is 10.75 (ten and three fourths) inches in one embodiment. Likewise, although the cylindrical wall 14 can weigh any amount, the cylindrical wall 14 may weigh 22 (twenty two) ounces or less in various embodiments.

It is to be understood that the word aluminum as used in the present application is broad enough to cover both aluminum and aluminum alloys. In accordance with one exemplary embodiment, the cylindrical wall 14 is made of aluminum alloy 2014-T6 and has a tensile yield strength of 180 MPa and an ultimate tensile strength of 200 MPa. In accordance with another exemplary embodiment, the cylindrical wall 14 is made of 6069 heat treatable Mg—Si—Cu aluminum alloy and has a tensile yield strength of 338 MPa and an ultimate tensile strength of 400 MPa. The cylindrical wall 14 can be made of aluminum and have an ultimate tensile strength up to 400 MPa in accordance with certain exemplary embodiments. Alternatively, the cylindrical wall 14 can be made of aluminum and have an ultimate tensile strength from 400 MPa to 650 MPa in accordance with other exemplary embodiments. In accordance with yet other exemplary embodiments, the cylindrical wall 14 is made of pure aluminum.

Although shown in FIGS. 3-5 as having a single gripping element 22, it is to be understood that multiple gripping elements 22 can be used in other embodiments. For example, from 2 (two) to 5 (five) gripping elements 22 may be present in other versions of the cylindrical wall 14. The length of the gripping element 22 in the direction of axis 90 is 4.75 (four and three fourths) inches in one embodiment, but it is to be understood that this length may be different in other embodiments. For example, the gripping element 22 may be from 0.5 (one half) inch to 6 (six) inches in length in the direction of axis 90 in other embodiments.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A grease gun, comprising:
a grease container having a cylindrical wall made of aluminum, said cylindrical wall defining an interior for holding grease, said cylindrical wall having an inner surface and an outer surface;
a first piston disposed at least partially in said interior of said cylindrical wall, wherein said first piston has a resilient member that engages said inner surface about the circumference of said inner surface, and wherein said first piston has a spring that biases said resilient member towards an end of said cylindrical wall, and wherein said first piston has a rod disposed through said spring, and wherein said first piston is configured for urging grease in said interior of said cylindrical wall into a chamber; and
a second piston configured for urging grease in said chamber out of said chamber, and wherein said second piston is configured to urge grease at a higher pressure than said first piston.

2. The grease gun as in claim 1, wherein said cylindrical wall is seamless.

3. The grease gun as in claim 1, wherein said outer surface of said cylindrical wall defines a gripping element thereon.

4. The grease gun as in claim 3, wherein a single said gripping element is present on said outer surface, and wherein said gripping element is formed by a plurality of pyramid shaped members arranged next to one another, wherein said plurality of pyramid shaped members are formed by stamping said outer surface.

5. The grease gun as in claim 1, wherein said cylindrical wall has a thickness from 0.0625 inches to 0.25 inches.

6. The grease gun as in claim 1, wherein said cylindrical wall weighs at most 22 ounces.

7. The grease gun as in claim 1, wherein said cylindrical wall has a length and wherein the inner diameter of said cylindrical wall is consistent throughout said length of said cylindrical wall such that said inner surface of said cylindrical wall is smooth along said length of said cylindrical wall.

8. The grease gun as in claim 1, wherein said cylindrical wall is formed by extrusion, and wherein said cylindrical wall has threading on opposite ends thereof.

9. The grease gun as in claim 1, further comprising:
a mounting member that carries said resilient member, wherein said mounting member is attached to said rod; and
a handle attached to said rod, wherein force exerted on said handle by a user causes said mounting member and said resilient member to be moved in said interior and causes said spring to compress.

10. The grease gun as in claim 1, further comprising a hand lever in communication with said second piston, wherein actuation of said hand lever causes said second piston to actuate.

11. A grease gun, comprising:
a grease container having a cylindrical wall made of aluminum, said cylindrical wall defining an interior, said cylindrical wall is seamless and has an inner surface and an outer surface, said outer surface defines a gripping element thereon.

12. The grease gun as in claim 11, wherein said cylindrical wall has a thickness from 0.0625 inches to 0.25 inches.

13. The grease gun as in claim 11, wherein said cylindrical wall weighs at most 22 ounces.

14. The grease gun as in claim 11, wherein said cylindrical wall has a length and wherein the inner diameter of said cylindrical wall is consistent throughout said length of said cylindrical wall such that said inner surface of said cylindrical wall is smooth along said length of said cylindrical wall.

15. The grease gun as in claim 11, wherein a single said gripping element is present on said outer surface, and wherein said gripping element is formed by a plurality of pyramid shaped members arranged next to one another, wherein said plurality of pyramid shaped members are formed through a molding process.

16. The grease gun as in claim 11, wherein said cylindrical wall is formed by extrusion, and wherein said cylindrical wall has threading on opposite ends thereof.

17. The grease gun as in claim 11, further comprising:
a first piston disposed at least partially in said interior of said cylindrical wall, wherein said first piston has a resilient member that engages said inner surface about the circumference of said inner surface, and wherein said first piston has a spring that biases said resilient member towards an end of said cylindrical wall, and wherein said first piston has a rod disposed through said spring; and
an end cap carried on an end of said cylindrical wall.

18. The grease gun as in claim 17, wherein said first piston is configured for urging grease in said interior of said grease container into a chamber, and further comprising a second piston configured for urging grease in said chamber out of said chamber, and wherein said second piston is configured to urge grease at a higher pressure than said first piston.

19. The grease gun as in claim 18, further comprising a hand lever in communication with said second piston, wherein actuation of said hand lever causes said second piston to actuate.

20. A grease gun, comprising:
a grease container having a cylindrical wall made of aluminum, said cylindrical wall defining an interior, said cylindrical wall is seamless and has an inner surface and an outer surface, said outer surface defines a gripping element, wherein said cylindrical wall has a thickness from 0.0625 inches to 0.25 inches, and wherein said cylindrical wall weighs at most 22 ounces, wherein said cylindrical wall has a length and wherein the inner diameter of said cylindrical wall is the same throughout the length of said cylindrical wall such that said inner surface is smooth along the length of said cylindrical wall;
a first piston disposed at least partially in said interior of said cylindrical wall, wherein said first piston has a resilient member that engages said inner surface about the circumference of said inner surface, and wherein said first piston has a spring that biases said resilient member towards an end of said cylindrical wall, and wherein said first piston has a rod disposed through said spring, and wherein said first piston is configured for urging grease in said interior of said cylindrical wall into a chamber; and
a second piston configured for urging grease in said chamber out of said chamber, and wherein said second piston is configured to urge grease at a higher pressure than said first piston.
